(19) United States
(12) Patent Application Publication
(10) Pub. No.: US 2015/0104146 A1
(43) Pub. Date: Apr. 16, 2015

(54) DEVICE AND CONTROL METHOD THEREOF

(71) Applicants: Kabushiki Kaisha Toshiba, Tokyo (JP); Toshiba Lifestyle Products & Services Corporation, Tokyo (JP)

(72) Inventors: Yasukazu HIGUCHI, Kawasaki (JP); Yoshihiro OHMORI, Tokyo (JP)

(21) Appl. No.: 14/470,694

(22) Filed: Aug. 27, 2014

(30) Foreign Application Priority Data
Oct. 16, 2013 (JP) 2013-215867

(51) Int. Cl. H04N 5/93; G08C 19/00; H04N 21/436; G08C 17/00; G11B 31/00; H04N 21/41

(52) U.S. Cl. CPC H04N 5/93; G11B 31/00; H04N 21/4131; H04N 21/4126; H04N 21/4135; H04N 21/43622; G08C 17/00; G08C 19/00; G08C 2201/91; G08C 2201/92
USPC 386/234

(57) ABSTRACT

One embodiment provides a device including a processor, a detector and a controller. The processor acquires a first operation state of a network-connected device, a second operation state of a video recorder and content information regarding a content playable by the video recorder. The detector detects a movement of a user including a start of a movement of a user away from the video recorder toward the network-connected device. The controller performs a control of an operation of the video recorder by using the second operation state and the movement of the user after a change of the first operation state if the first operation state is changed after a detection of the start of the movement of the user.

### CROSS-REFERENCE TO RELATED APPLICATION(S)

This application claims priority from Japanese Patent Application No. 2013-215867 filed on Oct. 16, 2013, the entire contents of which are incorporated herein by reference.

### FIELD

Embodiments described herein relate generally to a device and its control method.

### BACKGROUND

Wearable devices are expected to become a major trend in the future. Such wearable devices may be required to cooperate with a household appliance such as a TV receiver each other. For example, it may be required to enable automatic time-shift viewing in response to suspension of content viewing, so that a user is allowed to view a content in a simple manner using efficiently short segments of time, such as gaps of houseworks and waiting times available in housework.

In view of above, for example, there is proposed a technique in which positions of a network-compatible household appliance and a user are measured and recorded, and the state of the household appliance is changed upon a user manipulation. However, in this technique, it is necessary to measure a state of the household appliance and a user position. Furthermore, the state of a household appliance is recognized only when it is manipulated, that is, no consideration is given to suspension etc.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is a block diagram showing the hardware configuration of a walk analyzing device according to a first embodiment.

FIG. 2 is a block diagram showing the hardware configuration of a video recorder used in the first embodiment.

FIG. 3 is a block diagram showing the functional configuration of a system according to the first embodiment or a second embodiment.

FIG. 4 is a flowchart of a wearable terminal according to the first embodiment.

FIG. 5 is a flowchart of a wearable terminal according to the second embodiment.

### DETAILED DESCRIPTION

One embodiment provides a device including: a processor configured to acquire a first operation state of a network-connected device, a second operation state of a video recorder and content information regarding a content playable by the video recorder; a detector configured to detect a movement of a user including a start of a movement of a user away from the video recorder toward the network-connected device; and a controller configured to perform a control of an operation of the video recorder by using the second operation state and the movement of the user after a change of the first operation state if the first operation state is changed after a detection of the start of the movement of the user.

Embodiments will be hereinafter described.

### Embodiment 1

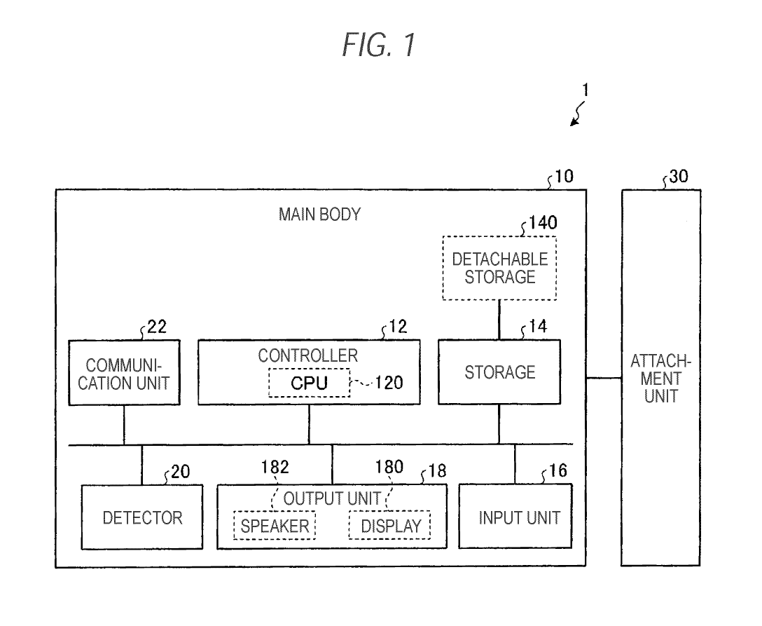

A first embodiment will be described below with reference to FIGS. 1-4.

FIG. 1 shows an example configuration of a walk analyzing device 1 as a wearable device (wearable terminal) according to this embodiment. As shown in FIG. 1, the walk analyzing device 1 includes a main body 10 and a attachment unit 30.

The main body 10 includes a controller 12, a storage 14, an input unit 16, an output unit 18, a detector 20, and a communication unit 22. Incorporating a CPU 120, for example, the controller 12 controls components of the main body 10. Incorporating a ROM (read-only memory; not shown), a RAM (random access memory; not shown), etc., the storage 14 stores a program to be run by the controller 12 and data etc. to be used when the controller 12 runs the program. A detachable storage 140 such as a memory card which can exchange programs and data with the storage 14 may be detachably attached to the main body 10.

The input unit 16, which consists of input keys, switches, etc., receives a user input to the main body 10. The output unit 18, which includes a display 180 such as a liquid crystal panel, a speaker 182 for outputting a sound, a vibrator (not shown), etc., outputs a state, an operation result, etc. of the main body 10 in the form of at least one of a screen display, a sound, and vibration. The input unit 16 and the display 180 may be integrated together using a touch panel or the like.

The detector 20 is, for example, a 3-axis acceleration sensor having a sampling frequency 128 Hz, and has an acceleration measurement range of, for example, ±6 G or wider. When the walk analyzing device 1 is manipulated by a subject person of a walk analysis, the detector 20 detects acceleration values in three directions, that is, the vertical direction, a movement direction of the subject person, and a horizontal direction (left-right direction) that is approximately perpendicular to the movement direction of the subject person.

The communication unit 22, which is a general-purpose interface for communicating with the outside, is configured so as to be able to perform any of a wired communication, a long-distance wireless communication, and a near-field wireless communication.

For example, the attachment unit 30 is a belt to be wound around the user's waist or the like. The user can ware the walk analyzing device 1 on the waist via the attachment unit 30.

While worn by a subject person at his or her waist or its neighborhood, the walk analyzing device 1 detects acceleration values in the vertical direction (Y direction), a movement direction (Z direction) of the subject person, and a horizontal direction (X direction) that is approximately perpendicular to the movement direction of the subject person. Since acceleration is integrated into speed which is integrated into displacement, in principle it is possible to, for example, perform calculation to judge whether a subject person has returned to an original position. For detailed functions of the walk analyzing device 1, refer to JP-2013-094316-A which if filed by the present applicant, for example.

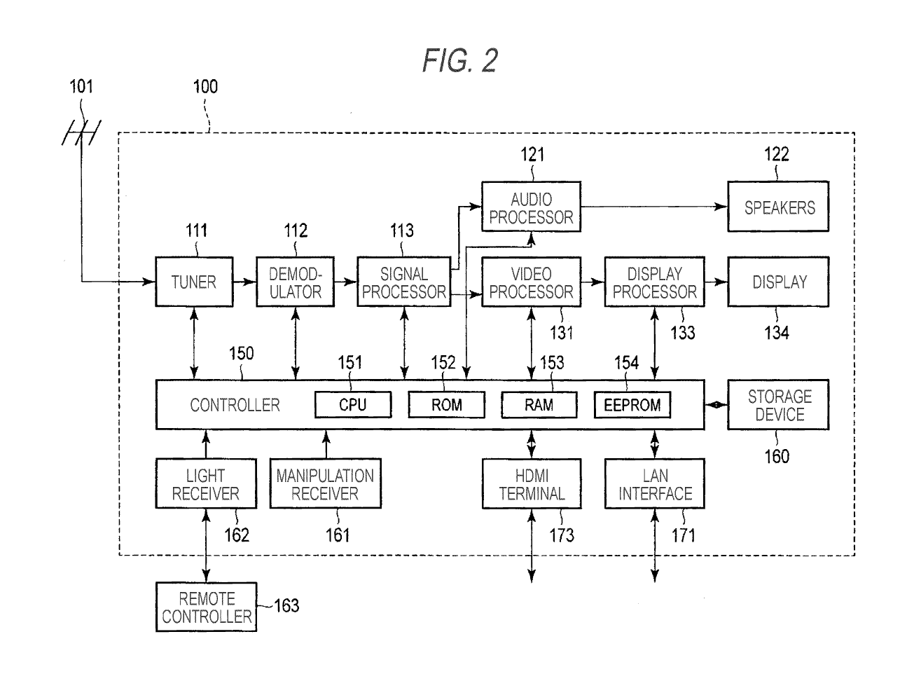

FIG. 2 shows an example video recorder 100 used in this embodiment. The video recorder 100 includes a tuner 111, a demodulator 112, a signal processor 113, an audio processor 121, a video processor 131, a display processor 133, a controller 150, a storage device 160, a manipulation receiver 161, a light receiver 162, a LAN interface 171, and an HDMI terminal 173. The video recorder 100 is also equipped with speakers 122 and a display 134.

The tuner 111 can receive, for example, a digital broadcast signal that is received by an antenna 101. For example, the antenna 101 can receive a ground-wave digital broadcast signal, a BS (broadcasting satellite) digital broadcast signal, and/or a 110° CS (communication satellite) digital broadcast signal.

The tuner 111 is a tuner for digital broadcast signals. The tuner 111 performs tuning on a received digital broadcast signal and supplies a resulting digital broadcast signal to the demodulator 112.

The demodulator 112 demodulates the received digital broadcast signal and thereby acquires content data such as a transport stream (TS) from the digital broadcast signal. The demodulator 112 inputs the acquired content data to the signal processor 113. As such, the antenna 101, the tuner 111, and the demodulator 112 function as a content data receiver.

The signal processor 113 performs signal processing such as separation of the content data. That is, the signal processor 113 separates the content data into a digital video signal, a digital audio signal, and a data signal. The signal processor 113 supplies the separated video signal to the audio processor 131, the video processor 131, and the controller 150, respectively.

Under the control of the controller 150, the signal processor 113 can convert the content data into data (recording stream) that is in a recordable state. Under the control of the controller 150, the signal processor 113 can supply the recording stream to the storage device 160 or another module that is connected to the HDMI terminal 173.

The signal processor 113 can convert the bit rate of the content data from an original rate to another rate (transcoding). That is, the signal processor 113 can transcode a stream having an original bit rate that is acquired from a broadcast signal or the like into a stream having a lower bit rate by, for example, lowering the frame rate. Thus, the signal processor 113 makes it possible to record a content in a state that it has a smaller amount of data.

The audio processor 121 converts the digital audio signal received from the signal processor 113 into an audio signal having a format playable by the speakers 122. For example, the audio processor 121 converts the digital audio signal into analog audio signals through digital-to-analog conversion and supplies the resulting analog audio signals to the speakers 122. The speakers 122 generate a sound based on the received analog audio signals.

The video processor 131 converts (i.e., decodes) the digital video signal received from the signal processor 113 into a video signal having a format playable by the display 134. The video processor 131 supplies the decoded video signal to the display processor 133.

Under the control of the controller 150, the display processor 133 performs processing for adjusting the image quality such as the hue, brightness, sharpness, and contrast on the received video signal. The display processor 133 supplies the image-quality adjusted video signal to the display 134. The display 134 displays video based on the received video signal.

For example, the display 134 includes a liquid crystal display device incorporating a liquid crystal display panel having a number of pixels arranged in matrix form and a backlight for illuminating the liquid crystal panel, and other components.

The video recorder 100 may be configured so as to be equipped with a supply terminal through which to supply a video signal, instead of the display 134. The video recorder 100 may be configured so as to be equipped with supply terminals through which to supply audio signals, instead of the speakers 122. And the video recorder 100 may be configured so as to be equipped with a supply terminal through which to supply a digital video signal and a digital audio signal.

The controller 150 controls operations of components of the video recorder 100. The controller 150 includes a CPU 151, a ROM 152, a RAM 153, an EEPROM (electrically erasable programmable read-only memory) 154, etc. The controller 150 performs any of various kinds of processing in accordance with a manipulation signal that is supplied from the manipulation receiver 161.

The CPU 151 includes a computation element for performing various kinds of computation processing and other elements. The CPU 151 realizes various functions by running programs stored in the ROM 152, the EEPROM 154 etc.

The ROM 152 stores programs for controlling the video recorder 100, programs for realizing various functions, and other information. The CPU 151 activates a program stored in the ROM 152 in accordance with a manipulation signal that is supplied from the manipulation receiver 161. In this manner, the controller 150 controls operations of the components.

The RAM 153 functions as a work memory of the CPU 151. That is, the RAM 153 stores a computation result of the CPU 151, data read by the CPU 151, and other information.

The EEPROM 154 is a nonvolatile memory for storing various kinds of setting information, programs, etc.

The storage device 160 has a storage medium for storing a content. For example, the storage device 160 is a hard disk drive (HDD), a solid-state drive (SSD), a semiconductor memory, or the like. The storage device 160 can store a recording stream that is supplied from the signal processor 113.

For example, the manipulation receiver 161 includes manipulation keys, a touch pad, or the like that generates a manipulation signal in accordance with a manipulation input of a user. The manipulation receiver 161 may be configured so as to receive a manipulation signal from a keyboard, a mouse, or another input device capable of generating a manipulation signal. The manipulation receiver 161 supplies the manipulation signal to the controller 150.

The touch pad incorporates a capacitance sensor, a thermosensor, or another type of device which generates position information. Where the video recorder 100 includes the display 134, the manipulation receiver 161 may include, for example, a touch panel that is integrated with the display 134.

For example, the light receiver 162 includes a sensor for receiving a manipulation signal from a remote controller 163. The light receiver 162 supplies a resulting signal to the controller 150. The controller 150 receives the signal from the light receiver 162 and amplifies and A/D-converts it to restore the original manipulation signal transmitted from the remote controller 163.

The remote controller 163 generates a manipulation signal based on a user manipulation input, and transmits the generated manipulation signal to the light receiver 162 by an infrared communication. The light receiver 162 and the remote controller 163 may be configured so as to transmit and receive a manipulation signal by another type of wireless communication such as one using radio waves.

The LAN interface 171 is an interface for a communication with another device on a network such as the Internet, an intranet, or a home network via a LAN. For example, the video recorder 100 can receive, through the LAN interface 171, a content that is recorded in a device on a network and play back it. Furthermore, the video recorder 100 can supply content data to a device that is connected to it through the LAN interface 171.

The LAN interface 171 may be an interface that communicates with an access point over a wireless LAN. For example, the LAN interface 171 has a function of performing a communication according to IEEE 802.11b/g/n.

Where as described above the LAN interface 171 is connected to an access point over a wireless LAN, the video recorder 100 can communicate with another device that is connected to the access point. The LAN interface 171 may be configured so as to communicate with another device over a wireless LAN directly, that is, without using an access point.

The HDMI terminal 173 is an interface for performing a communication according to such a standard as a high definition multimedia interface (HDMI (Trademark)). A device that is compatible with HDMI, such as a Blu-ray (Trademark), a DVD recorder, or a hard disk recorder, is connected to the HDMI terminal 173. The HDMI terminal 173 can receive content data that is supplied from a device connected to it.

The controller 150 causes input, to the signal processor 113, of content data that is received through the HDMI terminal 173. The signal processor 113 separates a digital video signal, a digital audio signal, etc. from the received content data. The signal processor 113 supplies the separated digital video signal and digital audio signal to the video processor 131 and the audio processor 121, respectively.

The video recorder 100 includes a power unit (not shown). The power unit receives power from, for example, a commercial power line via an AC adapter, converts the received AC power into DC power, and supplies the latter to the individual units of the video recorder 100.

Incidentally, the time-shift viewing has come into wide use as it has become common for digital TV receivers to incorporate the HDD recording function. And the time-shift viewing has made it possible to view contents efficiently, that is, without being restricted by their broadcast schedule. However, at present, to perform time-shift viewing, a user needs to cause recording and play-back manually by himself or herself. In daily life, manual time-shift viewing is not necessarily performed efficiently.

For example, when content viewing is done in a waiting time in the case where a device operates for a prescribed time in housework such as washing and drying, in many cases content viewing cannot be finished with such timing as to be suitable for the housework. Either the housework or the content viewing is half-finished. When content viewing is suspended halfway due to finishing of such housework as washing, it is necessary to manually perform manipulations for enabling time-shift viewing such as a start of recording, chapter addition, a halt, etc. Similar manipulations are necessary when viewing is restarted.

In contrast, improvements could be made if an operation state of a household appliance and a user action (movement) state can be acquired. As the TV manipulating function with cooperation between a TV receiver and an external device has become common, platforms have been constructed that allow a smartphone or a tablet terminal to perform more complicated TV controls than a remote controller. However, at present, this technique is merely used on a level of, say, a remote controller working on a smartphone.

A description will be made below as to how to perform time-shift viewing efficiently based on the following points by adding a household appliance to cooperation between a TV receiver and an external device with advancement of adaptation to computerization of household appliances as exemplified by, for example, the ECHONET Lite standard, a rise of the expectation for the household appliances cooperation technology, and expansion of user action (movement)-based services using a mobile terminal and controlling the TV receiver based on an operation state of the household appliance and user actions (movements) by the external device (wearable device):

(1) To enable efficient time-shift viewing, household appliance operation state information and user action (movement) information are used and a TV receiver is controlled by an external link device (wearable device).

(2) An expected operating time of a household appliance is acquired when it is manipulated. When a user has stopped his or her actions (movements), viewing of a content that can be viewed fully by the end of the operation of the household appliance is recommended, and a TV receiver is manipulated in accordance with a user selection.

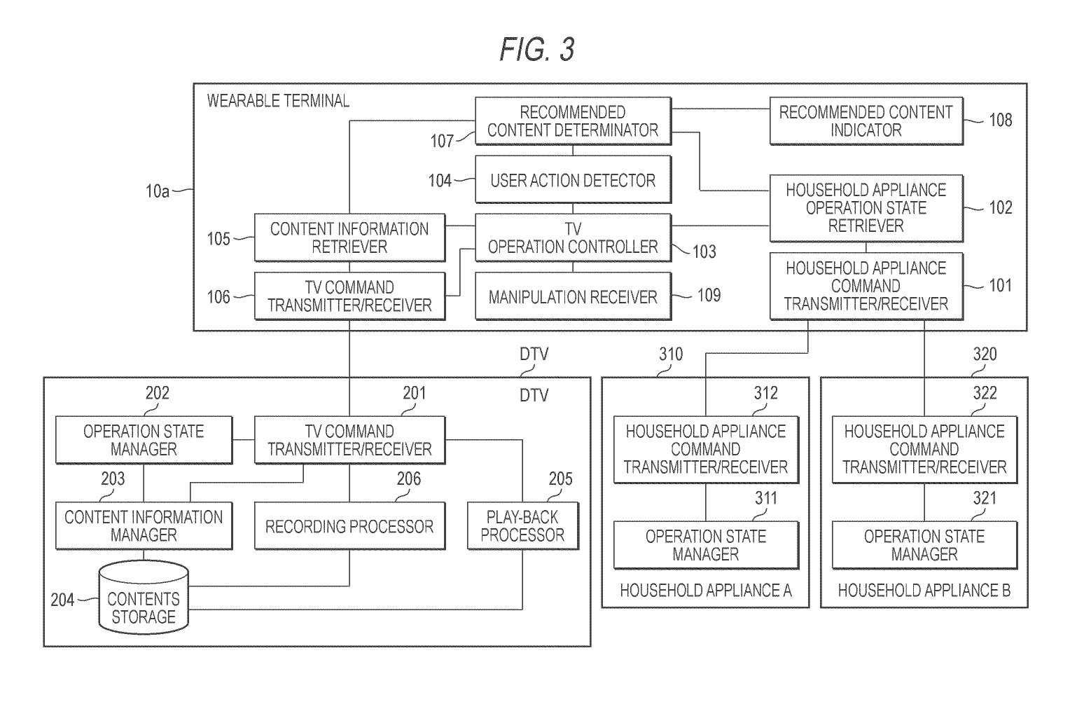

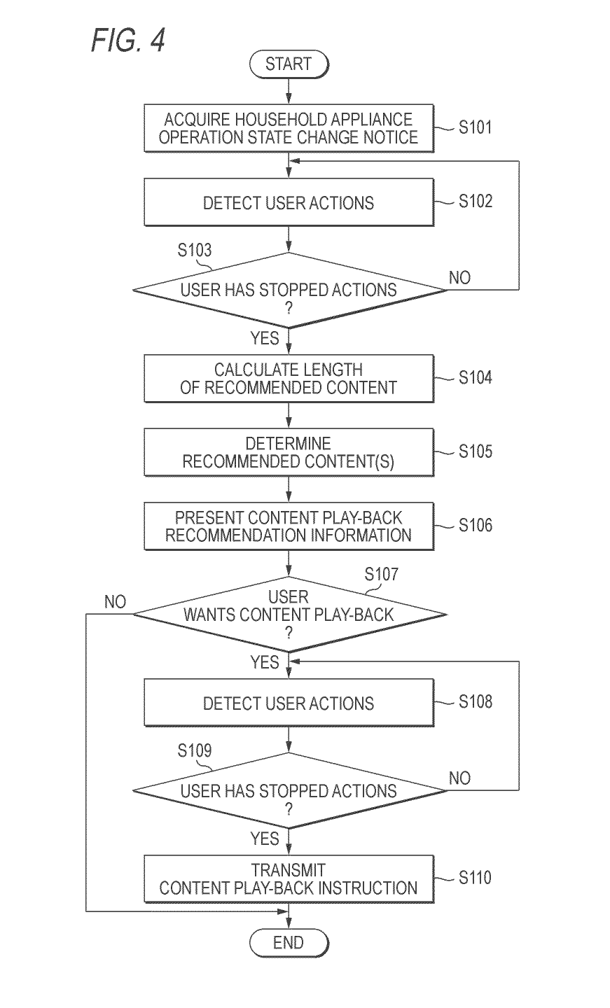

FIGS. 3 and 4 exemplify a wearable terminal which determines and recommend a content that can be viewed fully by the end of operation of a household appliance from when a user is rendered in a standby state. FIG. 3 is a functional block diagram of a system including a wearable terminal 10a and the video recorder 100. The wearable terminal 10a may be configured with the main body 10 and the attachment unit 30 of the above-described walk analyzing device 1. As the attachment unit 30, any of various forms such as a glove, a wrist band, and a headset may be adopted.

As shown in FIG. 3, the wearable terminal 10a includes various function units, that is, a household appliance command transmitter/receiver 101, a household appliance operation state retriever 102, a TV operation controller 103, a user action (movement) detector 104, a contents information retriever 105, a TV command transmitter/receiver 106, a recommended content determinator 107, a recommended content indicator 108, and a manipulation receiver 109. While these functional units are implemented mainly by the controller 12, the household appliance command transmitter/receiver 101 and the TV command transmitter/receiver 106 also correspond to the communication unit 22, the user action (movement) detector 104 corresponds to the detector 20, the recommended content indicator 108 corresponds to the output unit 18, and the manipulation receiver 109 corresponds to the input unit 16.

As shown in FIG. 3, a DTV (digital television set), which is an example of the video recorder 100, includes various function units, that is, a TV command transmitter/receiver 201, an operation state manager 202, a contents information manager 203, a contents storage 204, a play-back processor 205, and a recording processor 206. These function units are implemented by programs that are run by the CPU 151. The TV command transmitter/receiver 201 performs a communication through the LAN interface 171, and the contents storage 204 uses the storage device 160. The play-back processor 205 and the recording processor 206 use the units shown in the top part of FIG. 2.

This example is directed to a case that a washing machine 310 as a household appliance A is manipulated. The washing machine 310 is connected to a network, and has a function of communicating and providing an operation state of its own to and with another device connected to the network. More specifically, this function is implemented by using the ECHONET Lite standard, for example. Likewise, the DTV has is connected to the network, and has a function of communicating and providing an operation state of its own and a function of allowing another terminal on the network to make an instruction to change a TV operation such as recording/playing-back processing or a setting of the DTV and to thereby cause the change. These devices are also connected to a home network. When the user sets a washing course for the washing machine 310 and starts washing, a household appliance command transmitter/receiver 312 receives a washing start notice containing a time to be taken by the washing from an operation state manager 311, and communicates operation start information to the wearable terminal 10a which is connected to the same network.

Referring to FIG. 4, at step S101, when receiving a notice through the household appliance command transmitter/receiver 101, the wearable terminal 10a acquires an operation start time and an operating time of the washing machine 310 by the household appliance operation state retriever 102 and stores the household appliance operation start time and operating time in the storage 14 by the recommended content determinator 107. At steps S102 and S103, the wearable terminal 10a attempts to detect a state that the user is not making any action (movement) by the user action (movement) detector 104. The term “actions (movements)” means body movements. If the body movement of the user falls within prescribed ranges (in the vertical and horizontal directions) for a prescribed time, it is judged that user is not moving, that is, the user is making any action (movement).

If it is detected that actions (movements) of the user have stopped, at step S104 the recommended content determinator 107 calculates a length of a content whose viewing should be recommended based on a time when user actions (movements) stopped and the recorded household appliance operation start time and operating time. More specifically, the recommended content determinator 107 calculates a length of a recommended content by subtracting a time that has elapsed from the household appliance operation start time to the stop of actions (movements) of the user from the household appliance operating time.

At step S105, the contents information retriever 105 of the wearable terminal 10a acquires a list of viewable contents from the DTV through the TV command transmitter/receiver 106 and the recommended content determinator 107 determines a content(s) that conforms to the length of a recommended content. For example, the recommended content determinator 107 produces a list of contents whose lengths are shorter than the calculated length and that are arranged in descending order of lengths. Alternatively, a control may be made so as to play back a most proper content (e.g., a longest content among ones whose lengths are within the calculated length or a content that is judged highest in the degree of recommendation based on user taste information) automatically instead of letting the user select one.

At step S106, the recommended content indicator 108 presents the determined recommended content(s) to the user. The manipulation receiver 109 receives information indicating whether the user wants to view the presented content (or one of the presented contents). If the user does not want to view the presented content (S107: no), the process is finished. If the user wants to view the presented content (S107: yes), the process moves to the next step S108.

At step S108 and S109, the wearable terminal 10a attempts to detect a state that the user is not making any action (movement). A place where the user is not making any action (movement) after showing the intention of viewing the presented content can be considered a position for viewing the DTV. Therefore, if the user action (movement) detector 104 detects a state that the user is not making any action (movement), at step S110 the TV operation controller 103 transmits, to the DTV, an instruction to play back the content whose viewing was commanded by the user. Upon receiving the play-back instruction, the DTV starts content play-back processing. It is proper to take into consideration a time that is taken to finish execution of steps S108 and S109. A content that comes not to be fully viewable may be removed from the above-mentioned list of recommended contents to be presented to the user, upon occurrence of such a content.

The above-described process makes it possible to estimate a time slot in which a user waits for the end of an operation of a washing machine started by the user and allow the user to semi-automatically view a content that is suitable for the waiting time.

### Embodiment 2

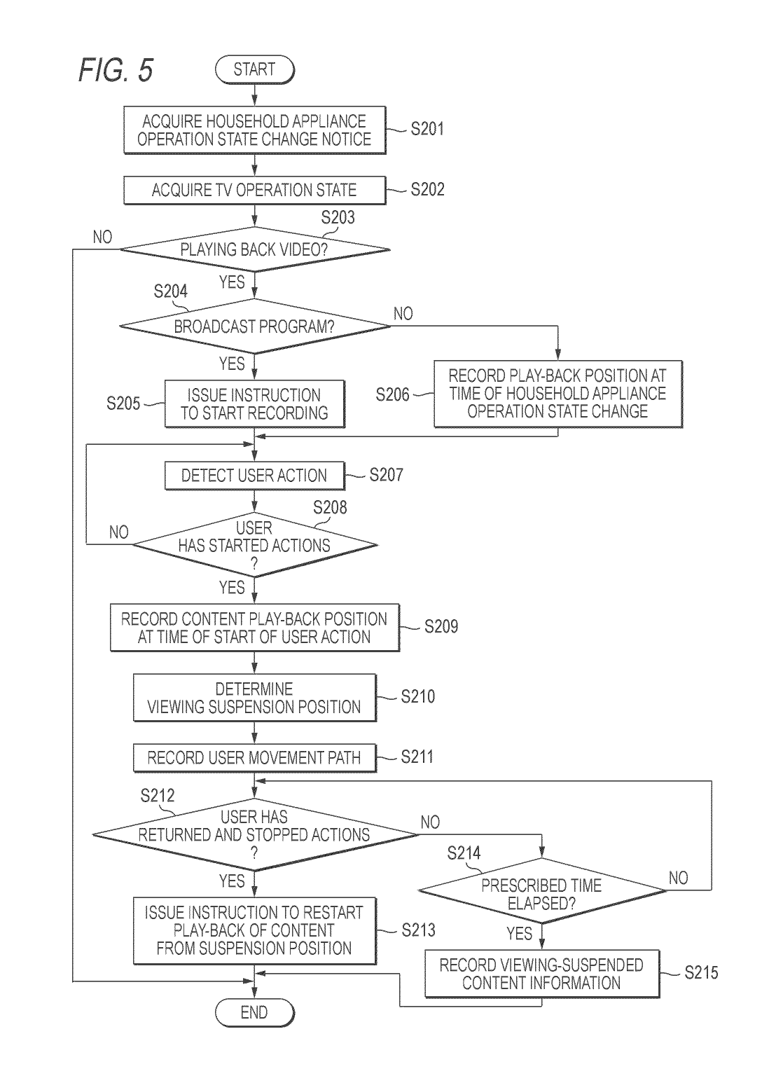

A second embodiment will be described with reference to FIGS. 3 and 5. Descriptions of items having the same ones in the first embodiment will be omitted.

A description will be made below as to how to perform time-shift viewing efficiently based on the following points:

(1) When a household appliance operation state change notice is received, a recording/playing-back position is stored automatically if a TV receiver is performing a playing-back operation.

(2) After the household appliance operation state change notice was received and the recording/playing-back position was stored automatically, a play-back position is stored automatically when a user has started an action (movement).

(3) After the household appliance operation state change notice was received and the recording/playing-back position was stored automatically, restart of play-back from one of the stored play-back positions is recommended when the user has completed the action (movement) and returned to an original position.

(4) After the household appliance operation state change notice was received and the recording/playing-back position was stored automatically, the recorded content is registered as a viewing-suspended content if a prescribed time has elapsed from the start of the action (movement) of the user. And viewing of the recorded content is recommended when the user starts next TV viewing.

A description will be made of a wearable terminal which, when a change occurs in the operation of a household appliance during view of a content and a user needs to take a proper measure, automatically suspends viewing of the content and restarts viewing of the content after taking a proper measure.

This example is directed to a case of notification of arrival of a visitor from an intercom 320 as a household appliance B. However, the concept of this embodiment is also applicable to an event of another kind of household appliance such as notification of a completion of an operation of a washing machine. The intercom 320 is connected to a network, and has a function of communicating and providing an operation state of its own. More specifically, this function is implemented by using the ECHONET Lite standard, for example. Likewise, the DTV has is connected to the network, and has a function of communicating and providing an operation state of its own and a function of allowing another terminal on the network to make an instruction to change a TV operation such as recording/playing-back processing or a setting of the DTV and to thereby cause the change.

These devices are also connected to a home network. Upon arrival of a visitor, an operation state manager 321 communicates an activation notice (operation start information) of the intercom 320 to the wearable terminal 10a which is connected to the same network, through a household appliance command transmitter/receiver 322.

Referring to FIG. 5, at step S201, when receiving a notice through the household appliance command transmitter/receiver 101, the wearable terminal 10a informs the user of activation of the intercom 320 and stores a current time in the storage 14. And the household appliance operation state retriever 102 acquires information indicating the start of an operation of the intercom 320. At steps S202 and S203, the TV operation controller 103 acquires, from the DTV, information indicating a current operation state of the DTV and judges whether or not the DTV is playing back video.

The process is finished if the DTV is not playing back video. If the DTV is playing back video, the process proceeds to next steps (steps S202 and S203). If the DTV is playing back video, at step S204 the TV operation controller 103 judges whether or not the DTV is playing back a broadcast program or a recorded content. If DTV is playing back a broadcast program, at step S205 the TV operation controller 103 instructs the DTV to start recording of the program being played back.

If DTV is playing back a recorded content, at step S206 the wearable terminal 10a records a current play-back position of the content (i.e., a time from the head of the content). At step S207 and S208, the wearable terminal 10a detects a start of an action (movement) of the user by the user action (movement) detector 104. If a start of an action (movement) of the user, at step S209 the TV operation controller 103 acquires and records a current time and a corresponding play-back position of the content being played back by the DTV.

At step S210, the wearable terminal 10a calculates a viewing suspension position to be used as a play-back start position when the user restarts viewing based on the recorded household appliance operation state change notification time and a user action (movement) start time. For example, if the difference between the household appliance operation state change notification time and the user action (movement) start time is smaller than a prescribed threshold value, a play-back position at the household appliance operation state change notification time may be employed as a viewing suspension position. If the difference is larger than the prescribed threshold value, a play-back position at the user action (movement) start time may be employed as a viewing suspension position. Alternatively, both play-back positions may be employed as suspension position candidates to cause the user to select one of them when play-back is restarted.

At step S211, the user action (movement) detector 104 records a relative movement path from an action (movement) start position while the user makes actions (movements). For example, a relative movement path can be calculated based on acceleration values in the respective directions that are detected by the acceleration sensor incorporated in the wearable terminal 10a and associated time points. If it is detected at step S212 that the user has stopped actions and the end point of the relative movement path is approximately the same as its start point, it can be presumed that the user has finished responding to the visitor over the intercom and returned to the original position. Therefore, at step S213, the wearable terminal 10a causes play-back from the viewing suspension position calculated at step S210.

At step S213, wearable terminal 10a may present play-back start position candidates.

If it is detected at step S212 that the user has not stopped actions or the end point of the relative movement path is not approximately the same as its start point, at step S214 the wearable terminal 10a judges whether or not the elapsed time from the start of the user actions (movements) is longer than is equal to a prescribed threshold value when the actions (movements) are not in a stop state. The wearable terminal 10a continues the detection processing if the elapsed time has not reached the prescribed threshold value yet. If the prescribed threshold time has already been reached, the process moves to step S215. If the user has not returned to the original position even after a lapse of the prescribed time or longer from the start of user actions (movements), it is supposed that it will take long time for the user to deal with the visitor (and do related work). Therefore, at step S215, the TV operation controller 103 records viewing-suspended content information and stops the DTV play-back processing. The recorded viewing-suspended content information will be used as information of one of recommended contents when the user wants to view a content on another occasion. This allows the user to avoid failing to view the rest of the content concerned.

With the above-described process, even when a user is forced to suspend viewing of a content due to occurrence of an intercom call during the viewing, it becomes possible to estimate user actions (movements) and control a TV receiver so that viewing can be restarted automatically as soon as the user finishes responding to the visitor over the intercom (and doing related work).

As is understood from the above description, the household appliance operation state retriever 102, the user action (movement) detector 104, and the TV operation controller 103 of the wearable (mobile) terminal 10a enables a more practical content play-back control because a household appliance operation state and user actions (movements) can be taken into consideration. Since user actions (movements), rather than user positions, can be used, no devices for position measurement are necessary, as a result of which the invention can be implemented at a low cost.

The system including the DTV and the wearable terminal 10a has been described above. Another system is possible in which a DTV and a wearable terminal are linked by a smartphone or a PC. This is to solve problems relating to the battery capacity and the processing ability of the wearable terminal by restricting its roles to transmitting detected information to a smartphone or the like and presenting, to a user, a notice received from the smartphone or the like.

The invention is not limited to the above embodiments, and various modifications are possible without departing from the spirit and scope of the invention. And various inventive concepts may be conceived by properly combining plural components of each embodiment. For example, several ones of the components of each embodiment may be omitted. Furthermore, components of different embodiments may be combined as appropriate.

1. A device comprising:
a processor configured to acquire a first operation state of a network-connected device, a second operation state of a video recorder and content information regarding a content playable by the video recorder;
a detector configured to detect a movement of a user comprising a start of a movement of a user away from the video recorder toward the network-connected device; and
a controller configured to perform a control of an operation of the video recorder by using the second operation state and the movement of the user after a change of the first operation state if the first operation state is changed after a detection of the start of the movement of the user.

2. The device of claim 1, further comprising:
a content information indicator configured to present the content information; and
a manipulation receiver configured to receive a selection of content on the presented content information by the user,
wherein the content information retriever presents a recommended content list upon change of the first operation state, and the controller controls the video recorder to play back the content selected through the manipulation receiver.

3. The device of claim 1,
wherein, upon change of the first operation state, the processor acquires an expected operating time of the network-connected device, acquires the content information, and determines a recommended content by comparing the expected operating time of the network-connected device with a content length corresponding to the acquired content information, and
wherein the controller controls the video recorder to play back the recommended content upon the stop of the movement of the user.

4. A device comprising:
a processor configured to acquire a first operation state of a network-connected device, a second operation state of a video recorder and content information regarding a content playable by the video recorder;
a detector configured to detect a movement of a user comprising a stop of a movement of a user away from the network-connected device toward the video recorder; and
a controller configured to perform a control of an operation of the video recorder by using the second operation state and the movement of the user after a change of the first operation state if the first operation state is changed after a detection of the stop of the movement of the user.

5. The device of claim 4,
wherein, upon change of the first operation state, the processor acquires a play-back state, and the controller controls the video recorder, when it is playing back a broadcast program, to record the broadcast program, and
wherein, upon the stop of the movement of the user, the controller controls the video recorder to play back the recorded broadcast program from a recording start position.

6. The device of claim 4,
wherein, upon change of the first operation state, the processor acquires a play-back state, and the controller controls the video recorder, when it is playing back a recorded program, to record a current play-back position, and
wherein, upon the stop of the movement of the user, the controller controls the video recorder to play back the recorded program from the recorded play-back position.

7. The device of claim 5,
wherein, upon elapse of a prescribed time without detection of the stop of the movement of the user, the controller controls the video recorder to save the recording start position.

8. The device of claim 6,
wherein, upon elapse of a prescribed time without detection of the stop of the movement of the user, the controller controls the video recorder to save the recorded play-back position.

9. A method comprising:
preparing a device comprising:
a processor configured to acquire a first operation state of a network-connected device, a second operation state of a video recorder and content information regarding a content playable by the video recorder; and
a detector configured to detect a movement of a user comprising a start of a movement of a user away from the video recorder toward the network-connected device; and
performing, using the device, a control of an operation of the video recorder by using the second operation state and the movement of the user after a change of the first operation state if the first operation state is changed after a detection of the movement of the user.

10. A method comprising:
preparing a device comprising:
a processor configured to acquire a first operation state of a network-connected device, a second operation state of a video recorder and content information regarding a content playable by the video recorder; and
a detector configured to detect a movement of a user comprising a stop of a movement of a user away from the network-connected device toward the video recorder; and
performing, using the device, a control of an operation of the video recorder by using the second operation state and the movement of the user after a change of the first operation state if the first operation state is changed after a detection of the movement of the user.
